(19) United States
(12) Patent Application Publication
(10) Pub. No.: US 2006/0011310 A1
(43) Pub. Date: Jan. 19, 2006

(54) Automatic equalizer for blinds

(76) Inventor: Tser-Wen Chou, Yorba Linda, CA (US)

Correspondence Address: BIRCH STEWART KOLASCH & BIRCH, PO BOX 747, FALLS CHURCH, VA, 22040-0747, US

(21) Appl. No.: 10/892,283

(22) Filed: Jul. 16, 2004

(51) Int. Cl. E06B 9/30

(52) U.S. Cl. 160/178.1 R

(57) ABSTRACT

The present invention discloses an automatic equalizer for blinds, which comprises two arc grooves disposed at the center of one end of an equalizer body corresponding to a wavelike protrusion for being coupled with a lid of the same shape; a first thread hole, a fourth thread hole, a second thread hole and a third thread hole being disposed parallel to each other along the same axial direction on a protruded end of an external side of one of the arc grooves and the bottom of a protruded end of another arc groove respectively, and the aforementioned thread holes passing through another end of the equalizer body. By means of the thread holes on the two arc grooves for passing and looping a pulling string, the pulling string can be pulled two-way corresponding to the looping, such that the looped pulling string is located at the tying end at the lower track of the blinds and the pulling force of the pulling string can be balanced, and thus achieving the function of equalizing the vertical movement of the blinds.

### FIELD OF THE INVENTION

The present invention relates to an automatic equalizer, more particularly to an automatic equalizer for blinds.

### BACKGROUND OF THE INVENTION

The present invention relates to the technical area of automatic equalizers for blinds. With the special design of building thread holes on two arc grooves of an equalizer body in the same axial direction, a pulling string can pass and loop through the thread holes of the two arc grooves to equalize the pulling force of the pulling string and the vertical movement of the blinds. Since offices, homes, and restaurants install blinds onto windows for the purpose of decorating the interior, sheltering sunlight and protecting privacy. A blind is an accessory item for a building to shelter light and protect one's private activity from being peeped by others at will, and thus are extensively used. There are various kinds of blinds, and the common blind generally comprises several shutters connected sequentially one by one below an upper track, a lower track disposed at the bottom of the shutter, two parallel pulling strings disposed between each shutter and passing through an automatic stopper and vertically disposed at one side of the blind, and a pulling ring disposed at the end of the two pulling strings for synchronously control the two pulling strings such that each shutter can be pulled up and down steadily and synchronously.

However, the structure of the foregoing traditional pulling ring as shown in FIG. 1 generally has a central penetrating hole at the center, and the hole allows the pulling string to pass through and to be tied at the rear end. If it is necessary to pull the pulling string to change the drooping length as the shutter are lifted or lowered. While the pulling string is pulled to change the drooping length, a user cannot move the shutters vertically up and down evenly (since the pulling force is not even, it is difficult to maintain a balanced vertical movement of the shutters as shown in FIG. 2). Further, each pulling string is tied at a fixed end of the thread hole of the pulling ring, and it is easy for each pulling string to be tied at a point and thus tangles the string easily as shown in FIG. 3.

### SUMMARY OF THE INVENTION

Since the design of the aforementioned blinds has the foregoing shortcoming on moving the shutters vertically up and down, an improvement on the pulling ring for a better application of the blinds is definitely required in order to equalize the pulling force of the pulling string and the vertical movement of the shutters.

Therefore, the inventor of the present invention based on years of experience on the design and manufacture of blinds to profoundly study the foregoing issue that the pulling ring cannot equalize the pulling force of the pulling string and the vertical movement of the shutters and aggressively find a solution by performing extensive researches and experiments, and finally invented an automatic equalizer for blinds that can equalize the pulling force of a pulling string and the vertical movements of the shutters.

The primary objective of the present invention is to provide an automatic equalizer for blinds that can equalize the pulling force of a pulling string and the vertical movement of the shutters. The equalizer body comprises two arc grooves disposed at the centre of one end of the equalizer body corresponding to a wavelike protrusion, a first and a forth thread holes and a second and a third thread holes being aligned parallel with each other in the same axial direction and disposed on a protruded end on the external side of one of the arc grooves and a protruded end on the internal side of the other arc groove respectively. The foregoing thread holes penetrate the other end of the equalizer body. With the thread holes of the two arc grooves for passing and looping the pulling string, the pulling string can be pulled two way for the looping, and the looped pulling string can be tied to a fixed end at the lower track of the blinds as to equalize the pulling force of the pulling string and the vertical movement of the shutters.

Another objective of the present invention is to provide an equalizer for passing and looping two pulling strings. Since the two arc grooves are disposed at one end of the equalizer body and a lid having an engaging member of the same shape is added, the bottom of the arc groove have partitions, and thus the thread holes are aligned parallel with each other in the same axial direction and will not coiled or tangled after the pulling string is passed.

A further objective of the present invention is to provide an equalizer that can adjust the pulling string and the fixed end disposed at the lower track of the shutters for tying each pulling string when the pulling force of the pulling string is uneven in order to facilitate equalizing the pulling force of the pulling string.

To make it easier for our examiner to understand the objective of the invention, its structure, innovative features, and performance, we use a preferred embodiment and the attached drawings for the detailed description of the invention.

### BRIEF DESCRIPTION OF THE DRAWINGS

FIG. 1 is a perspective view of the pulling ring and blinds according to a prior art.

FIG. 2 is a front view of the pulling ring and blinds as depicted in FIG. 1.

FIG. 3 is a side view of the pulling string as depicted in FIG. 1.

FIG. 4A is an exploded view of the equalizer body and the lid of the equalizer according to the present invention.

FIG. 4B is a cross-sectional view of Section 4B-4B of FIG. 4A.

FIG. 5 is a perspective view of the equalizer body according to the present invention.

FIG. 6 is an illustrative view of the pulling string passing through the equalizer body according to the present invention.

FIG. 7 is an illustrative view of another pulling string passing through the equalizer body according to the present invention.

FIG. 8A is a side view of the pulling string according to the present invention.

FIG. 8B is an enlarged view of a section of the pulling string as depicted in FIG. 8A.

FIG. 9 is an exploded view of the lid according to another preferred embodiment of the present invention.

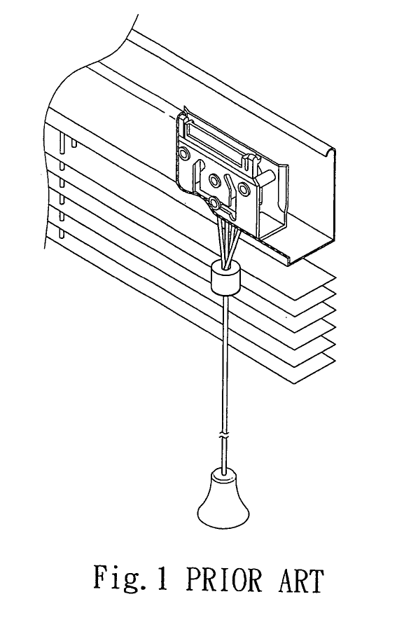

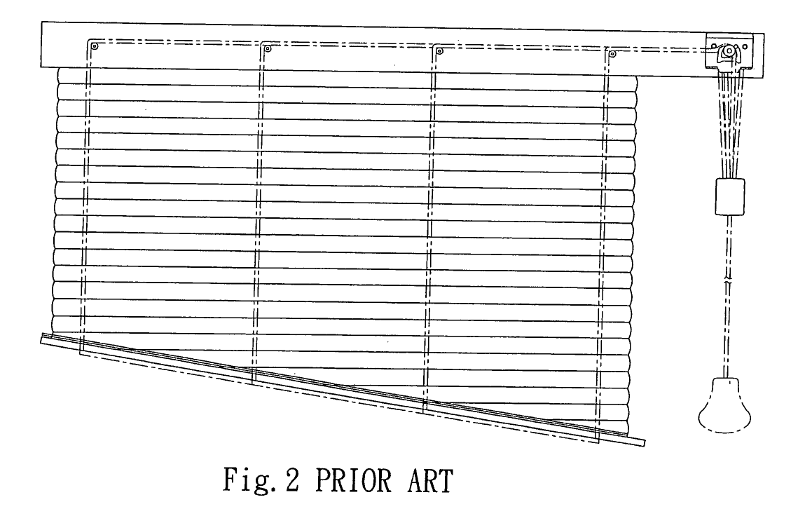

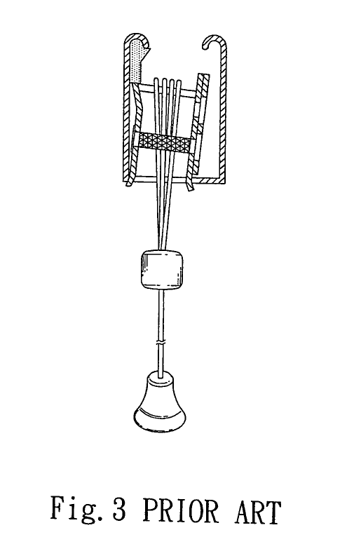

### DETAILED DESCRIPTION OF THE PREFERRED EMBODIMENTS

The present invention discloses an automatic equalizer for blinds that can equalize the pulling force of a pulling string and the vertical movement of blinds.

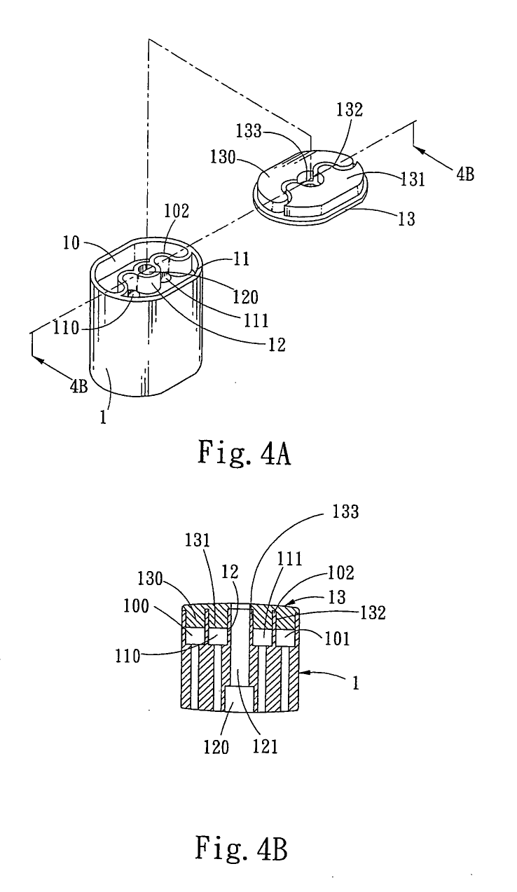

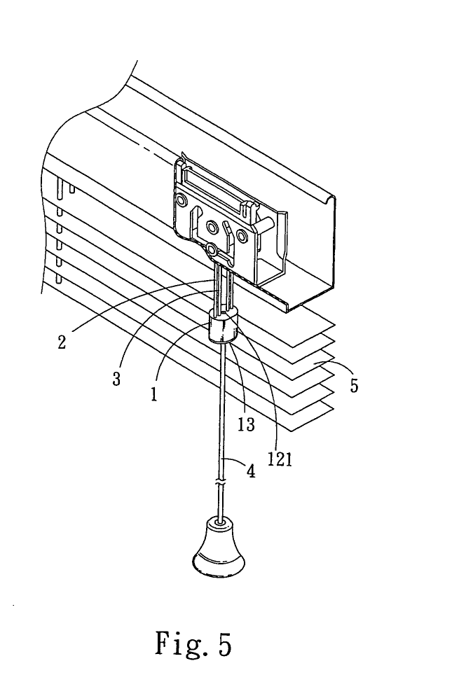

Please refer to FIG. 4A. A wavelike protrusion 102 partitioned by two arc grooves 10, 11 is disposed at the center of an end of an equalizer body 1, a first and a fourth thread holes 100, 101 and a second and a third thread holes 110, 111 are parallel to each other along the same axial direction and disposed at a protruded end of the external side of one of the arc grooves 10 and the bottom of a protruded end of the internal side of the other arc groove 11. The first, fourth, third and fourth thread holes 100, 101, 110, 111 penetrate the other end of the equalizer body 1. A protruded circular rod 12 coupled to the two corresponding central positions has a through hole 120. A buried hole 121 is disposed at the end of the through hole 120 for tying and fixing a pulling string 4 (As shown in FIG. 5) in the buried hole 121.

Two engaging members 130, 131 having the same shape as the two arc grooves 10, 11 are disposed on an end surface of the lid 13. A wavelike groove 132 and its central hole 133 are disposed between the two engaging members 130, 131 for coupling the two engaging members 130, 131 into the arc grooves 10, 11 at one end of the equalizer body 1.

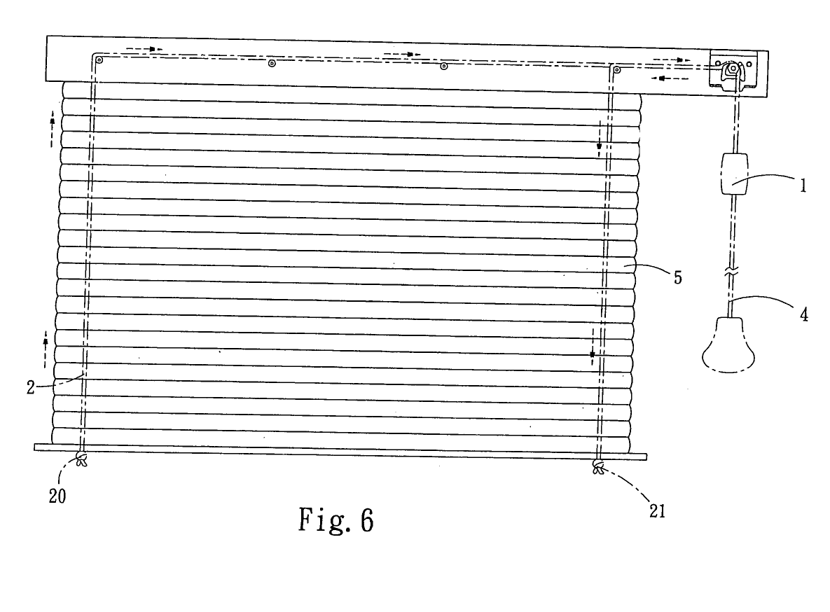

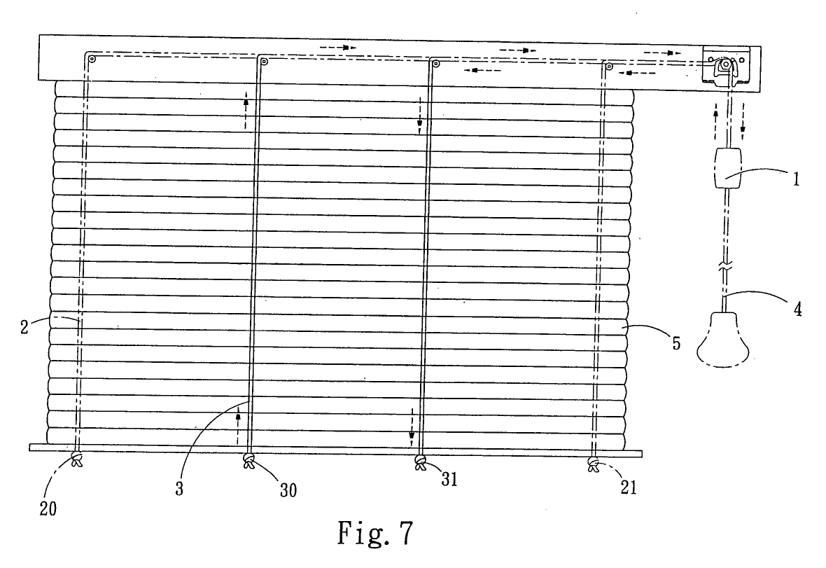

Please refer to FIGS. 4A and 4B for the detailed structure of an automatic equalizer for blinds according to the preferred embodiment of the present invention. The equalizer body 1 comprises two arc grooves 10, 11 partitioned by a corresponding wavelike protrusion 102 disposed at the center of an end, and the bottom of the protruded ends on both sides of the arc grooves 10, 11 are disposed along the same axial direction and aligned parallel to the first and fourth thread holes 110, 111. The aforementioned thread holes 100, 101, 110, 111 penetrate to another end of the equalizer body 1, and the first, fourth, second and third thread holes 100, 101, 110, 111 disposed on the external and internal sides of the two arc grooves 10, 11 are provided to pass and loop the pulling strings 2, 3 (As shown in FIG. 5) respectively to define a two-way corresponding winding mode, such that the looped pulling strings 2, 3 form a first knot 20, a fourth knot 21 (As shown in FIG. 6), a second knot 30 and a third knot 31 (As shown in FIG. 7) at the lower track 50 of the shutters 5 as to achieve the effects of equalizing the pulling force of the pulling strings 2, 3 and the vertical movement of the shutters 5.

Please refer to FIG. 5 for the assembly adopted by this invention. The equalizer body 1 evacuates an arc groove 10, 11 at one end, and a first, a fourth, a second, and a third thread hole 100, 101, 110, 111 disposed at the bottom of the protruded end at the external and internal sides of the arc grooves 10, 11 along the same axial direction. A first knot 20 is tied at the lower track 50 along the external side of the pulling string 2 of the shutters 5 one by one first, and then passing the pulling string 2 through the shutter to the first thread hole 100 of its arc groove 10, and then looping the pulling sting 2 to its fourth thread hole 101 corresponding to its arc groove 10, and then coupled the internal side of the shutters and tie a fourth knot 21 at the lower track 50 as shown in FIG. 6.

Further, another pulling string 3 is tied at the lower track 50 to form a second knot 30 and passes through the internal side of the shutters 5 to the second thread hole 100 of another arc groove 11 and then looped to the corresponding thread hole 111 of another arc groove 11, and finally coupled to the edge corresponding to the internal side of the shutter 5 and tied a third knot 31 at the lower track 50 as shown in FIG. 7.

Therefore, when the shutters 5 are pulled down, an initializing string 4 is pulled downward to drive the equalizer body 1 to move downward accordingly. If a force is applied onto the equalizer body 1, then the shutters 5 are pulled downward. If the shutters 5 are found aslant, the knot at the inclined position is loosened to adjust the level of the shutters 5 to a horizontal level, and thus the user does not have to worry about the unbalanced force applied to the pulling strings 2, 3. The vertical movement of the shutters 5 can be equalized. Therefore, the two pulling strings 2, 3 pass through the equalizer body 1 and then loop through the shutters 5, such that the force exerted onto the internal and external sides of the shutters 5 corresponding to the pulling strings 2, 3 is even, and thus the pulling strings 2, 3 will not tangled to achieve the objective of preventing the occurrence of accidents and enhancing safety.

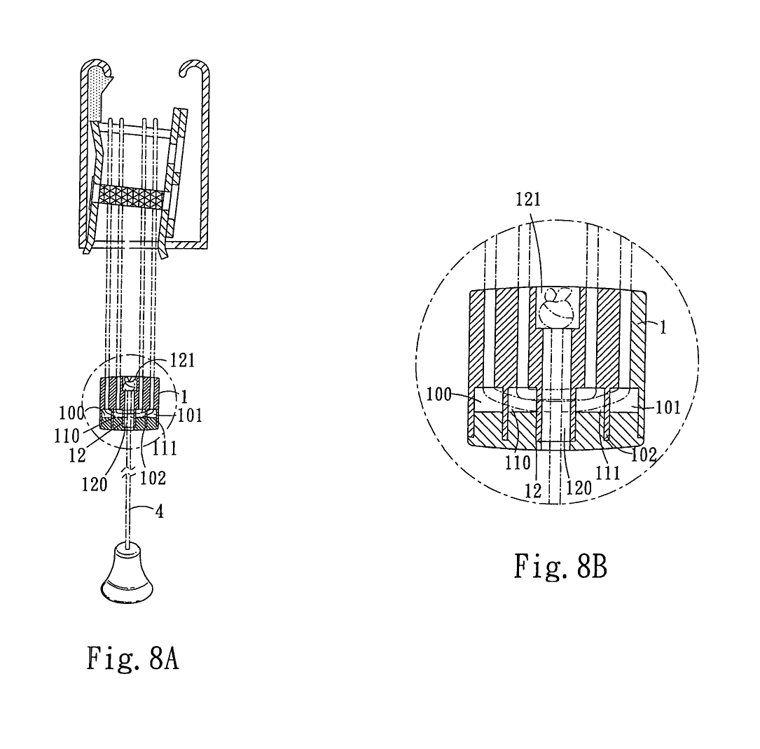

From the aforementioned structure, design and principle of motion as shown in FIGS. 8A and 8B, it is known that the equalizer body 1 of the present invention comprises two arc grooves 10, 11 disposed on one end of the equalizer body 1, a first and a four thread holes 100, 101 and a second and a third thread holes 100, 101 are disposed on the protruded end of the bottom of the two arc grooves 10, 11, and the foregoing thread holes 100, 101, 110, 111 allow the two pulling strings 2, 3 to tie a first and a second knot 20, 30 at the lower track 50 and then to be passed and looped to the internal and external sides corresponding to a fourth and a third knot 21, 31. Therefore, the equalizer body 1 can be used to achieve the effect of equalizing the pulling force of the pulling strings 2, 3 and the vertical movement of the shutters 5.

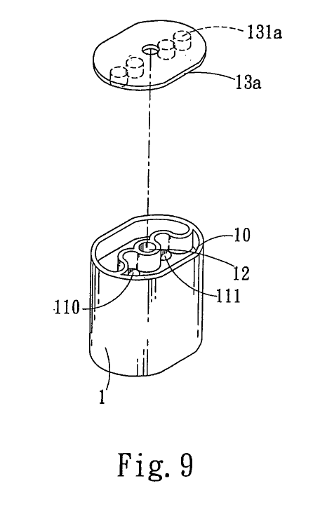

Please refer to FIG. 9. A lid 13 of the invention could also be the lid 13a as shown in the figure. The lid 13a at an end surface comprises a first and a fourth thread holes 100, 101 and a second and a third thread holes 110, 111 being corresponsive to and equidistant from a circular rod 131a. Such arrangement also can achieve the purpose of covering and connecting the two arc grooves 10, 11 of the equalizer body 1.

What is claimed is:

1. An automatic equalizer for blinds, comprising:
a wavelike protrusion, being disposed at the center of an end of an equalizer body, partitioned by two arc grooves, and covered and coupled by a lid of the same shape;
a protruded circular rod, coupled to the central position of said two arc grooves;
a first thread hole, a fourth thread hole, a second thread hole and a third thread hole, being respectively disposed at a protruded end at the bottom of the internal and external sides of said two arc grooves, such that said thread holes of said two arc grooves allowing a pulling string to be passed and looped to define a two-way corresponding looping mode.

2. The automatic equalizer for blinds of claim 1, wherein said thread holes are disposed parallel to each other and in the same axial direction.

3. The automatic equalizer for blinds of claim 2, wherein said thread holes pass through another end of said equalizer body.

4. The automatic equalizer for blinds of claim 1, wherein said protruded circular rod has a through hole.

5. The automatic equalizer for blinds of claim 4, wherein said through hole has a buried hole at an end and an initializing string is tied and fixed into said buried hole.

6. The automatic equalizer for blinds of claim 1, wherein said lid comprises a corresponding engaging member at an end surface and a wavelike groove and a central circular hole of said wavelike groove are formed between two engaging members.

7. The automatic equalizer for blinds of claim 6, wherein said lid at an end surface comprises a circular rod corresponding to and equidistant from a first and a fourth thread holes and a second and a third thread holes of said equalizer body.
